(19) United States
(12) Patent Application Publication
(10) Pub. No.: US 2001/0020592 A1
(43) Pub. Date: Sep. 13, 2001

(54) Method for determining the oxygen content of a measurement gas

(75) Inventors: Klaus-Peter Sandow, Amberg (DE); Silvia Lenaerts, Berchem (BE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/791,199

(22) Filed: Feb. 22, 2001

(30) Foreign Application Priority Data
Feb. 23, 2000 (DE) 100 08 441.9

(51) Int. Cl. G01N 27/407

(52) U.S. Cl. 205/784; 204/427

(57) ABSTRACT

A method is provided for determining the oxygen content of a measurement gas using a sensor, as well as the use of the sensor according to the method. The problem presents itself of making available a method by which lambda can be determined as accurately and as simply as possible in a broad range of 0.8 to about 20. The problem is solved for the method in that the determination of the oxygen content of the measurement gas is performed by the first and the second measuring cells in a serial manner, wherein the oxygen content of the measurement gas is determined by the second measuring cell in a lambda range of 0.8 to 1.4 and by the first measuring cell in a lambda range of ≧1 to 20.

### BACKGROUND OF THE INVENTION

The invention relates to a method for determining the oxygen content of a measurement gas using a sensor, as well as the use of the sensor according to the method. The sensor herein has an oxygen ion-conducting solid electrolyte, which separates the measurement gas from a reference gas, and which has at least one reference electrode on its reference gas side and a first and a second measuring electrode on its measurement gas side, and the first measuring electrode is covered by a diffusion-limiting layer. In the sensor a first measuring cell, which is formed by the covered first measuring electrode, the solid electrolyte and the reference electrode, is operated amperometrically according to the limiting current principle, and parallel thereto a second measuring cell, which is formed by the second measuring electrode, the solid electrolyte and the reference electrode, is operated potentiometrically.

German published patent application DE 197 57 112 A1 describes a gas sensor according to the generic concept for measuring the oxygen and/or air/fuel ratio lambda and at least one other gaseous component in gas mixtures. The measuring electrode on the measurement gas side and the reference electrode on the reference gas side of an oxygen ion-conducting solid electrolyte here simultaneously produce at least two measuring signals based on the same or different measuring principles and which represent different gaseous components. In particular, FIG. 7 shows a section through a tube-shaped gas sensor for the simultaneous potentiometric oxygen determination and amperometric oxygen and nitrogen oxide determination. A targeted evaluation of the individual sensor signals in specific gas compositions is not provided for.

German published patent application DE 43 20 881 A1 discloses a sensor for determining a lambda value in a gas mixture, in which a heated lambda probe with a step-shaped sensor characteristic and another heated lambda probe with a broadband sensor characteristic are combined. The output signal of the lambda probe with step-shaped sensor characteristic is used to calibrate the lambda probe with a broadband sensor characteristic. The here-disclosed lambda probe with step-shaped sensor characteristic makes a resistance jump at lambda equal 1, while the lambda sensor with broadband sensor characteristic has a continuously changing resistance, preferably changing linearly in the lambda range of 0.8 to 1.2. As sensitive materials for the two resistive lambda-probes, oxygen-sensitive layers are used. A determination of lambda greater than 1.2 is not possible with this sensor arrangement.

### BRIEF SUMMARY OF THE INVENTION

The problem presents itself of making available a method by which lambda can be determined in as accurate and as simple a manner as possible in a broad range of 0.8 to about 20.

The problem is solved for the method, in that the determination of the oxygen content of the measurement gas occurs in a serial manner by the first and the second measuring cell and that the oxygen content of the measurement gas is determined by the second measuring cell in a lambda range of 0.8 to 1.4 and by the first measuring cell in a lambda range of ≧1 to 20. A use and/or evaluation of the output signal of a measuring cell follows therefrom only if a certain lambda is present in the measurement gas. This thus involves a “serial switching” of the measuring range, by which an accurate measurement of lambda in the range of 0.8 to about 20is made possible, and the measurement accuracy is high both with high and with low lambda. Through an electronic control unit this selection of the appropriate output signal can result in a simple manner. Thus, for example, with a lambda of 0.8 to 1.4 the output signal of the second, potentiometrically operated measuring cell can be used for various regulation or control measures during combustion operations, preferably in a motor vehicle, while with a lambda of ≧1 to about 20, the output signal of the first measuring cell can be used for that purpose. In a lambda range of ≧1 to 1.4, in which both the output signal of the first measuring cell and the output signal of the second measuring cell are usable, the evaluation can occur in either a serial manner or a parallel manner.

It is advantageous herein, if in a lambda range of ≧1 to 1.4 an equilibration occurs between the potentiometric output signal of the second measuring cell and the amperometric output signal of the first measuring cell. This equilibration of the output signals can take place using an electronic control unit at a fixed lambda value or in certain time intervals. The equilibration of the output signals using an electronic control unit can, however, for example in a motor vehicle, also be triggered by certain engine data.

The accuracy of the measurement is further increased if the second measuring cell is calibrated regularly using a calibration value and/or output signal-target value stored in an electronic control unit, when the measurement gas is at a lambda value of 1. Then, the first measuring cell can be calibrated in an even more accurate manner using the second measuring cell. An additional recording of the current temperature of the measuring cells is advantageous for these calibration operations, in order to be able to determine and take into account purely temperature-related shifts of the output signals.

According to the invention for carrying out the method, a sensor can suitably be used having an oxygen ion-conducting solid electrolyte, which separates a measurement gas from a reference gas, and having at least one reference electrode on the reference gas side and a first and a second measuring electrode on the measurement gas side of the solid electrolyte, wherein the measuring electrodes are arranged independently of each other, and the first measuring electrode is covered by a diffusion-limiting layer.

Alternatively, for performing the method according to the invention, a sensor is excellently suited having an oxygen ion-conducting solid electrolyte, which separates a measurement gas from a reference gas, and having at least one reference electrode on the reference gas side and a first and a second measuring electrode on the measurement gas side of the solid electrolyte, wherein the measuring electrodes are arranged independently of each other, and the first measuring electrode is covered by a diffusion-limiting layer, and having a temperature sensor and/or electric heating element arranged electrically insulated from the solid electroly

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic illustration in longitudinal sectional view of an oxygen sensor for use in the present invention, having one potentiometrically operated measuring cell and one amperometrically operated measuring cell; and

FIG. 2 is a schematic illustration in cross-sectional view of an oxygen sensor of FIG. 1, having in addition a heating element.

### DETAILED DESCRIPTION OF THE INVENTION

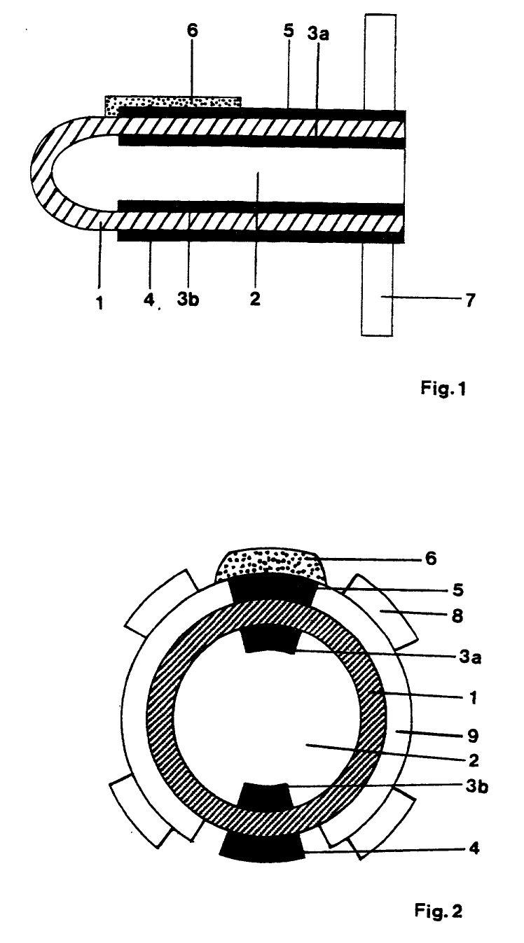

The Figures show, by way of example, an oxygen sensor usable for performing the method according to the invention. FIG. 1 shows an oxygen sensor having a tube-shaped oxygen ion-conducting solid electrolyte 1 closed on one end, which separates the reference gas side 2 from the measurement gas side. This separation is only indicated here by a wall 7, in which the oxygen sensor is installed with a housing (not shown). On the reference gas side 2 of the solid electrolyte 1, which is made, for example, of yttrium-doped ZrO₂, the reference electrodes 3a and 3b are located.

On the measurement gas side of the solid electrolyte 1, the measuring electrode 4 is located (shown here including electrical supply line), which together with the reference electrode 3b and the solid electrolyte 1 forms a measuring cell, which is used potentiometrically operated to determine lambda. Also located on the measurement gas side of the solid electrolyte 1 is the measuring electrode 5 (shown here including electric supply line), which is covered with a diffusion-limiting layer 6 and which forms, together with the reference electrode 3a and the solid electrolyte 1, another measuring cell, which is used amperometrically operated to determine lambda.

FIG. 2 shows the oxygen sensor of FIG. 1 in cross-section. In addition to the elements already described for FIG. 1, an electric heating element 8, for example made of platinum, is present. The heating element 8 is arranged insulated from the solid electrolyte 1 by an electrically insulating layer 9, for example made of aluminum oxide. In addition, a temperature sensor (not shown here) can be provided, for example on the reference gas side 2.

The following two examples give possibilities for using the oxygen sensor from the above-mentioned Figures for the method according to the invention. It is pointed out in this regard that the special lambda values selected in the examples were taken from the three lambda ranges given above, namely 0.8 to 1.4; ≧1 to about 20; and ≧1 to 1.4, merely to make clear the concept of the invention.

### EXAMPLE 1

A performance of the method according to the invention can be done in which an oxygen sensor according to FIG. 1 or FIG. 2 is installed in the exhaust gas system of a motor vehicle. Upon starting the motor the oxygen sensor is heated up to operating temperature by the heating element 8, and the lambda of the exhaust gas is determined with both measuring cells. Using the output signals of both measuring cells, an electronic control unit examines whether lambda in the measurement gas is above or below 1 and uses the output signal of the potentiometrically operated measuring cell when lambda ≦1.1 or the output signal of the amperometrically operated measuring cell when lambda is ≧1.1, for example for controlling the fuel supply of the motor vehicle. With a continuous increase of the lambda value in the exhaust gas, the use of the output signal changes at lambda 1.1 from the potentiometrically operated measuring cell to the amperometrically operated measuring cell.

### EXAMPLE 2

Example 1 can be optimized by the following additional method steps. If a lambda of 1.1 is measured with the potentiometric measuring cell, then the current output signal of the amperometric measuring cell of the oxygen sensor is calibrated. Using a lambda-current table stored in the electronic control unit, the output signal-target value is determined which corresponds to a lambda of 1.1 for the amperometrically operated measuring cell (here a current in A). The output signal-target value is then compared with the measured output signal, and a calibration of the amperometrically operated measuring cell is undertaken if there is a deviation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for determining the oxygen content of a measurement gas using a sensor having an oxygen ion-conducting solid electrolyte (1), which separates the measurement gas from a reference gas, and having at least one reference electrode (3a; 3b) on its reference gas side and a first and a second measuring electrode (4; 5) on its measurement gas side, and the first measuring electrode (5) is covered by a diffusion-limiting layer (6), the method comprising amperometrically operating a first measuring cell, which is formed by the covered first measuring electrode (5), the solid electrolyte (1) and the reference electrode (3a), according to the limiting current principle, parallel thereto potentiometrically operating a second measuring cell, which is formed by the second measuring electrode (4), the solid electrolyte (1) and the reference electrode (3b), and determining the oxygen content of the measurement gas in a serial manner by the first measuring cell (3a; 1; 5; 6) and the second measuring cell (3b; 1; 4), wherein the oxygen content of the measurement gas is determined by the second measuring cell (3b; 1; 4) in a lambda range of 0.8 to 1.4 and is determined by the first measuring cell (3a; 1; 5; 6) in a lambda range of ≧1 to 20.

2. The method according to claim 1, further comprising performing an equilibration in a lambda range of ≧1 to 1.4 between the potentiometric output signal of the second measuring cell (3b; 1; 4) and the amperometric output signal of the first measuring cell (3a; 1; 5; 6).

3. The method according to claim 2, wherein the equilibration of the output signals is done using an electronic control unit at a fixed lambda value.

4. The method according to claim 2, wherein the equilibration of the output signals is performed using an electronic control unit in certain time intervals.

5. The method according to claim 2, wherein the equilibration of the output signals is performed using an electronic control unit triggered by certain engine data.

6. The method according to claim 1, further comprising calibrating the second measuring cell (3b; 1; 4) in a lambda range of 0.8 to 1 using a calibration value stored in an electronic control unit.

7. The method according to claim 1, further comprising calibrating the first measuring cell (3a; 1; 5; 6) using the second measuring cell (3b; 1; 4).

8. The method according to claim 1, wherein the measuring electrodes (4; 5) are arranged independently of each other.

9. The method according to claim 1, wherein the sensor has a temperature sensor arranged insulated from the solid electrolyte (1).

10. The method according to claim 1, wherein the sensor has an electric heating element (8) arranged electrically insulated from the solid electrolyte (1).
